(19) United States
(12) Patent Application Publication
(10) Pub. No.: US 2015/0227872 A1
(43) Pub. Date: Aug. 13, 2015

(54) Method of Color Wheel Mapping for Scheduling

(71) Applicants: Thomas A. Widdows, Battle Ground, WA (US); Nicholas Waters, Battle Ground, WA (US)

(72) Inventors: Thomas A. Widdows, Battle Ground, WA (US); Nicholas Waters, Battle Ground, WA (US)

(21) Appl. No.: 14/616,660

(22) Filed: Feb. 7, 2015

Related U.S. Application Data
(60) Provisional application No. 61/937,193, filed on Feb. 7, 2014.

(51) Int. Cl. G06Q 10/06

(52) U.S. Cl. CPC G06Q 10/06312

(57) ABSTRACT

A method of using color mapping to enhance the efficiency and effectiveness of resource allocation and scheduling is provided. The method allows for efficient scheduling and coordinating the minute-by-minute access and allocation of a pool of resources such as, but not limited to, equipment, devices or people, to accommodate both planned and unplanned needs or events in the immediate to foreseeable future requires a comprehensive view of the available resources, their current and future planned locations, the current and future point of need, and available unscheduled time for each resource, among other factors.

### CROSS REFERENCE TO RELATED APPLICATIONS

The following application is based on and claims the priority benefit of U.S. provisional application Ser. No. 61/937,193 filed Feb. 7, 2014 currently co-pending; the entire contents of which are incorporated by reference.

### BACKGROUND

A method of using color mapping to enhance the efficiency and effectiveness of resource allocation and scheduling is provided. The method allows for efficient scheduling and coordinating the minute-by-minute access and allocation of a pool of resources such as, but not limited to, equipment, devices or people, to accommodate both planned and unplanned needs or events in the immediate to foreseeable future requires a comprehensive view of the available resources, their current and future planned locations, the current and future point of need, and available unscheduled time for each resource, among other factors. Moreover, when scheduling and coordinating the activities of multiple resources that are fungible relative to the need at hand, it's highly desirable to apply the closest resource to the need to minimize the time and cost of transporting the proper resource to the point of need. Finally, the present method provides the highly beneficial ability to quickly identify large distances between resources and needs to flag higher than average transport times and/or costs such as, but not limited to, vehicle fuel and, in some cases, lost revenue generation time.

Patents related to logistic analysis are known. For example, U.S. Pat. No. 7,930,052 to Virgil discloses a computer implemented system includes an integrated logistics support system and a product integrity analysis system that utilize an integrated database. The product integrity analysis system is operable to retrieve at least a portion of logistics data records from the database, calculate an anticipated integrity value of the product using the portion of logistics data records, and store the anticipated integrity value of the product in the database.

U.S. Pat. No. 7,890,475 to Demuth discloses software and content used by the software which are developed on a first computer system for use on a second computer system. Transferable forms of the developed software and content that may be used by the second computer system are created. The transferable form of the developed software is made available for transfer to the second computer system. The transferable form of the developed content is transferred to a content server that makes a transferable form of content used by software running on the second computer system available for receipt by the second computer system. The transferable form of the developed software from the first computer system and the transferable form of the content from the content server are received at the second computer system. The received software and content are translated into usable forms of the software and content that may be used by the second computer system.

However, these patents fail to describe a color-based logistic system which is easy to use and secure. Further, these patents fail to describe a color-based logistic system which saves time and resources.

### SUMMARY

Previous methods of logistic planning often utilize timelines and tables constantly revised on whiteboards, sticky notes constantly revised on walls (Figure A) or sophisticated and expensive software that tracks the availability of resources as a function of time and where the resources are needed as a function of time. The goal of all these methods is to provide the resource scheduler with a broad overview of the available resources at any given point in time so that quick identification of available resources can be assessed at the current or future time to allow allocations to occur in an manner with a high probability of execution. However, these systems often fall short in terms of efficiency. By the present system and method, a quick assessment of assignment options allows new optimization opportunities within adjacent time frames. As a result, the present system and method allow for increased efficiency in logistic planning

### BRIEF DESCRIPTION OF THE FIGURES

FIG. 1 illustrates a flow chart of the present method.

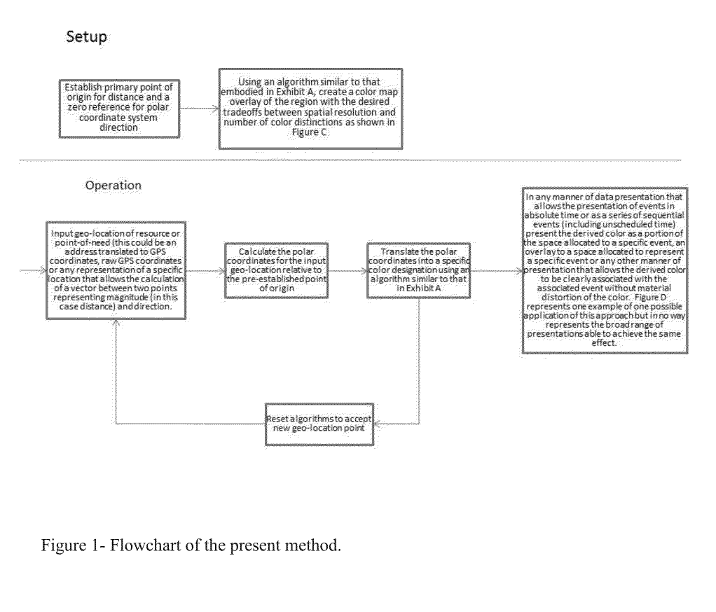

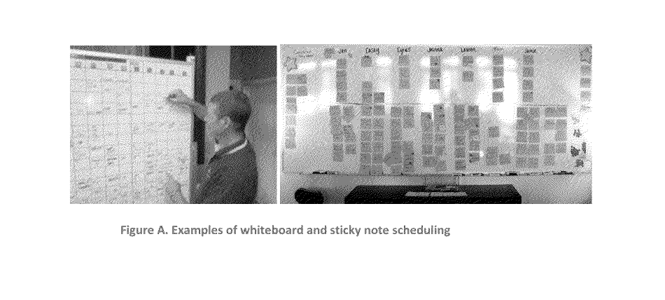

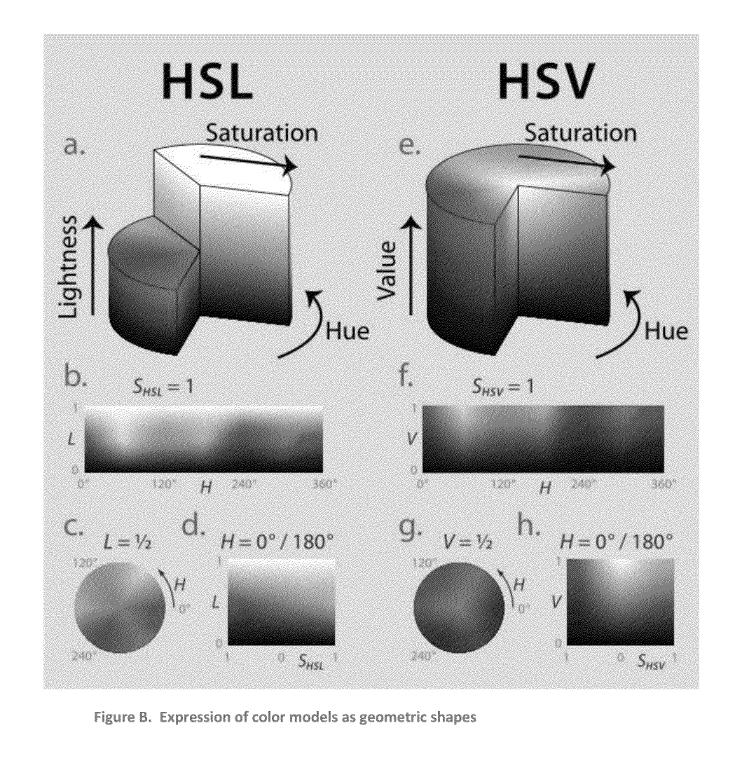

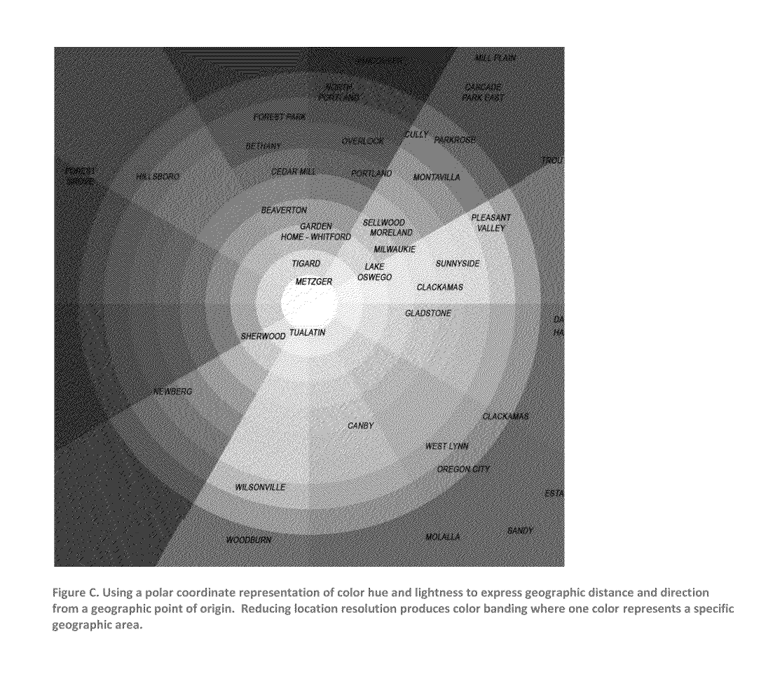

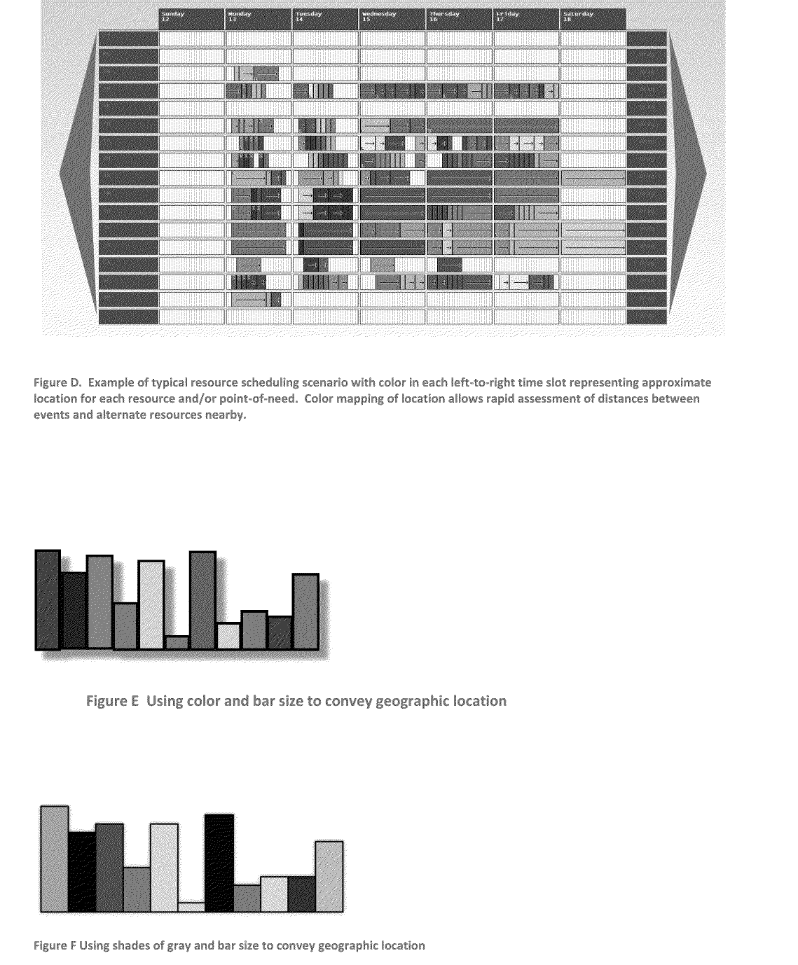

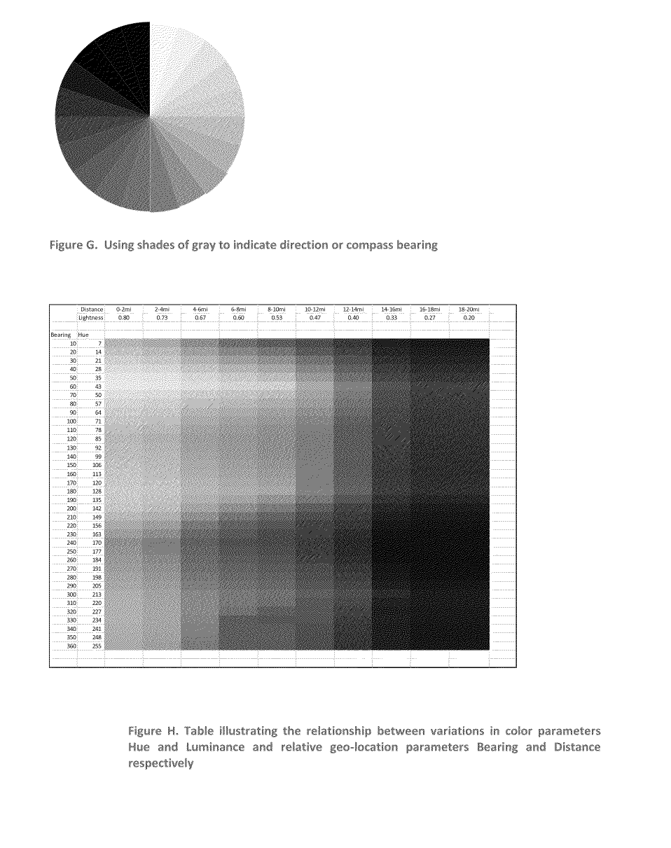

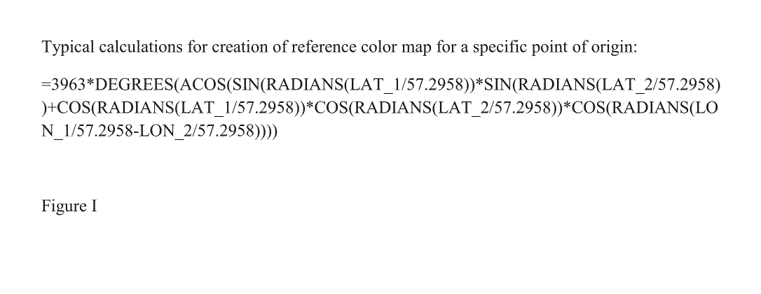

Figure A illustrates whiteboard and sticky note scheduling as is commonly used in other scheduling methods.

Figure B illustrates expressions of color models as geometric shapes.

Figure C illustrates a color wheel expressing geographic distance and direction.

Figure D illustrates an example of typical resource scheduling scenario.

Figure E illustrates a graph using color and bar size to convey geographic location.

Figure F illustrates shades of gray and bar size to convey geographic location.

Figure G illustrates a graph using shades of gray to indicate direction or compass bearing.

Figure H illustrates a table showing the relationship between variations in color parameters hue and luminance and the relative geo-location parameters bearing and distance respectively.

Figure I illustrates the typical calculations for creation of reference color map for a specific point of origin.

### DETAILED DESCRIPTION

A method of using color mapping to enhance the efficiency and effectiveness of resource allocation and scheduling is provided. The method allows for efficient scheduling and coordinating the minute-by-minute access and allocation of a pool of resources such as, but not limited to, equipment, devices or people, to accommodate both planned and unplanned needs or events in the immediate to foreseeable future requires a comprehensive view of the available resources, their current and future planned locations, the current and future point of need, and available unscheduled time for each resource, among other factors. Moreover, when scheduling and coordinating the activities of multiple resources that are fungible relative to the need at hand, it's highly desirable to apply the closest resource to the need to minimize the time and cost of transporting the proper resource to the point of need. Finally, the present method provides the highly beneficial ability to quickly identify large distances between resources and needs to flag higher than average transport times and/or costs such as, but not limited to, vehicle fuel and, in some cases, lost revenue generation time.

While computers can quickly assess and report parameters such as distance between a resource location and point of need at any given point in time, communicating those relationships over a broad range of resources and/or over a broad range of time can result in very large tables of numbers that are not intuitive and are often time consuming to interpret. Advances have been made in quickly communicating relative distance between resource and need by enabling computers to graphically map the location of needs and resources on a graphical representation of a physical map. However, when multiple resources are within in close proximity at a specific point in time, identifying individual resources often becomes an iterative process of either graphically zooming in to reveal more information about each icon or serially mousing over each icon to allow additional information about that icon to be displayed. Also, any attempt to display the location of multiple resources over time on a map overlay becomes increasingly hard to interpret as the period of time increases and the sheer number of positions on the map increases and the sense of available resources at a specific point in time is either lost or the user must again engage in an iterative process and/or scan of individual time slots to identify best use of resource. Under these conditions, identifying optimal scenarios can be difficult and/or time consuming. Creating multiple views designed to quickly communicate specific attributes eases interpretation effort but can require viewing multiple views to extract the scope of the desire information.

In the present method, embodied in a software application code, the approach described henceforth embodies a novel use of color to represent the location of a broad range of resources and points of need over a broad range of time in a manner that allows rapid visual identification of optimal allocation as well as highly intuitive analytics from a single information display. The resulting improvements in allocation and scheduling efficiency, effectiveness and analysis lead to material benefits including, but not limited to, gains in allocation and scheduling productivity, reductions in transport costs and improved utilization of resources.

In this approach, the context of a location is expressed in terms of color attributes. It is well understood that a broad range of colors are often modeled as a combination of three variables such as, but not limited to, Hue Saturation Lightness (HSL), Hue Saturation Value (HSV), Hue Saturation Intensity (HIS), etc. Further, the color models are often use geometric shapes such as cylinders, cubes, etc., to visualize how the three variables combine to provide a continuum of possible colors. In each cylinder, the angle around the central vertical axis corresponds to “hue”, the distance from the axis corresponds to “saturation”, and the distance along the axis corresponds to “lightness”, “value” or “brightness”. Note that while “hue” in HSL and HSV refers to the same attribute, their definitions of “saturation” differ dramatically. Because HSL and HSV are simple transformations of device-dependent RGB models, the physical colors they define depend on the colors of the red, green, and blue primaries of the device or of the particular Red Green Blue (RGB) space, and on the gamma correction used to represent the amounts of those primaries. Each unique RGB device therefore has unique HSL and HSV spaces to accompany it, and numerical HSL or HSV values describe a different color for each basis RGB space. As shown in Figure B created by Jacob Rus circa 2010, the concept of viewing a color's hue and saturation as a two dimensional (2D) circular disc expressed in polar coordinates where saturation is expressed as the distance from a point of origin (in this case, the center of the disc) and hue equates to direction across a span of zero to 360 degrees relative to the same point of origin and a specified reference point for zero degrees such as, but not limited to, red is well established.

It is also well understood that a geographic location can be expressed in terms of polar coordinates where any location on a 2D map can be expressed in terms of distance from a specified point of origin and direction expressed in degrees (0-360) relative to the same point of origin and a specified reference point for zero degrees such as, but not limited to, due North.

The present method may combine the polar coordinate models for color and geographic location to allow any two of the three color attributes to represent the distance and direction attributes of a geographic location as expressed in polar coordinates. The result is the ability to directly associate a specific color with a specific location or range of locations. As a result, a user may quickly identify optimal planning for the efficient movement of assets.

The accuracy of this expression of geo-location for a specific location may be dependent on the ability of the viewer to discern small changes in each color attribute. Given the average humans ability to discern minute changes in a single attribute is somewhat limited, this scheme may not be suitable for high-precision measurement of distance. However, for the purpose of identifying the relative proximity of resources to point-of-need or just the approximate location of a resource across a broad expanse, the discernible resolution is far more than adequate.

In fact, by reducing spatial resolution, fewer color distinctions are required allowing faster visual interpretation. This can be manifested by expressing an area of the polar map (Figure C) with a single color rather than a continuum of colors. Figure C provides an example of reducing the spatial resolution of a geo-location map. In this case, hue and lightness from the Hue Saturation Lightness (HSL) model were used to represent polar direction and distance respectively from a specified point of origin (point on a geographic map). The resolution of both direction and distance were reduced to create a banding effect that may allow relatively quick association of a specific discernible color to a specific geographic area.

Once the mapping of color to geo-location is established and becomes familiar for a specific application, the ability to associate a simple and small color indicator to any information will almost instantaneously convey location information to the observer. Compared to reading information such as an address, city name or zip code and mentally translating characters to an understanding of location, this approach leverages the incredible efficiency of human visual processing to draw rapid associations based on color mapping.

For example, once an observer becomes familiar with the relative position of dark blue and dark orange, seeing dark blue next to dark orange in a sequence of colors creates an incredibly fast realization that there is a huge distance represented between the two items. Extracting that same knowledge from text is far slower. The same level of efficiency in recognizing distance for two adjacent events can be achieved through identifying the items of interest and having them presented on a conventional map but that typically requires at least a request for a map view of that data which itself requires user interaction and time. Moreover, when multiple events are assessed on the same map or a long series of events is assessed, the information density of symbols on the map and maintaining the perspective of sequential order for multiple resource paths becomes problematic.

By comparison, Figure D shows how the location of each resource in a long sequence (row) of transitions from location to location driven by the point-of-need at each particular time slot. Moreover, if a request comes in for a resource at a location at a specific time, the color of the need location can be presented and through simple color matching, the observer can identify the closest resource in that time slot. The efficiency of visual color matching across a broad range of possible allocations is very high compared to conventional techniques.

The mapping of color to location shown in Figure D provides a unique perspective on resource management. By quickly assessing not only the location but the number of location changes and scale of the distance between adjacent allocations, the observer can rapidly identify large distances between sequential time slots and equally as fast identify relative proximities of other resources and the net impact of changing multiple schedules to reduce overall travel. All of the targeted locations are on display at once and distance between different color blocks becomes assessable in real time. If changes can be made to reduce overall travel, fuel costs incurred in traveling from location to location are reduced and travel time is reduced enabling more total jobs and/or more billable hours. Moreover, the efficiency of presenting a large block of sequential location information while being able to maintain the sequence for each individual resource allows practical real-time assessment of the organization's ability to address a specific resource request while the requester is on the phone—even if it requires moving assignments for multiple resources. This is very important since follow-up calls to confirm schedules can extend the processing time of resource requests up to 400% or more. Similarly, if a scheduled resource becomes available due to cancelations or miss-communications, the opportunities for reassignment can quickly be assessed, again including the high-level impact of moving several assignments to make it happen.

Another level of efficiency may come from the user being able to assess both distance and time allocations over a wide array of resources and over a relatively broad time horizon as shown in Figure D. Unlike other systems that require separate information displays to assess available resources, routing analytics, etc. Figure D contains key parameters for assessing many of these issues. Rather than requiring deliberate actions to enable route assessments, the data that would identify an issue is in front of you all the time, even when you're focused on specific scheduling activity. The result is an opportunity for faster issue discovery and resolution because the data needed is always in front of you.

While Figure D embodies a specific instance of the color to location mapping concept, it by no means defines the range of possible instantiations. Nor does the use of hue and lightness define the scope of viable color mappings. For any of the color specification models available using two or more parameters to define specific colors, any two of the parameters can be selected to generate a color to location mapping translation. Moreover, the color mapping can extend beyond polar coordinates and also use standard Cartesian coordinates. For example, the three variable RGB model where each variable is represented by the same linear range of values from 0 to 255 provides a straightforward mapping to a Cartesian coordinates for any two of the three variables. Finally, extension of this concept into 3D space is also straight forward. Any of the color models that use three or more parameters provide a straight forward mapping to 3D geometries as shown in previously referenced article. For example, the HSL and HSV models can be mapped to cylindrical models and RGB to cube based models. Alternatively, the third color variable could be mapped to a non-geographic variable and carry any type of information relevant to the activity at hand.

Finally, an alternate form of communicating graphically communicating location uses only one color model parameter, such as hue information, to convey direction and uses the size or percentage of color fill in a geometric shape to indicate distance. For example, the variation of hue in the sequence of vertical bars in Figure E indicates the direction of the resource location while the height of the color bar represents the distance from a point of reference. As the distance from the point of origin approaches the origin, the bar can become very small revealing a very small color area, however, since anything that small would by definition be close to the origin, it's practical to assume direction is immaterial since all such locations would be near each other regardless of direction. The advantage would be better interpretation of distance from people who have difficulty discerning more than one color attribute.

This same general principle can also be adapted to address users that are color blind. Figure F illustrates how shades of the color gray can be used to also communicate direction. Just like color, the various shades of gray can be assigned to a specific direction as illustrated in Figure G. In Figure G, the center of the circle represents the reference point of origin and each shade of gray is associated with a range of compass bearings indicating the general direction the desired location is. In this example, the lightest shade of gray indicates magnetic north. By increasing the number of shades available, the resolution of the bearing can be increased.

In companies, government agencies or institutions that operate over large areas with multiple centers for sourcing resources, a fully developed software system would need to provide the ability to designate which resource center was the most appropriate and then change the point of origin and/or bearing reference of the color mapping system to provide an accurate assessment of color interpretation, such as, but not limited to, proximity, for that resource center. In fact, a national dispatch center responsible for hundreds of resource centers, distribution points, distributors, etc. could use this color mapping technology to identify which resource center would best handle a request and then use that information to select and enter the appropriate point of origin, bearing and distance scale for that resource center and then optimize fulfilling the resource request.

It should be understood that all reference to color presented herein includes the use of gray as a color and a grayscale as the variation of a single color parameter. Further, the below-identified steps represent only one possible implementation of the present method; however, any number of steps may be used to create the mappings between color and location. When implementing the present method, calculations may be based on any planar or multi-dimensional coordinate system selected by the software developer. For simplicity, in this example, the coordinate system for identifying physical geographic location and selecting color are the same. They could be different but would require an intermediate translation step. For this description, the coordinate system is assumed to be polar unless stated otherwise.

### Steps in Utilizing the Method

1) Converting common geographic location references into a numeric representation such as, but not limited to, latitude and longitude. Such algorithms are well established and commercially available.

2) Identify/select the point of origin from which all color assignments will be established. Typically this could be, but is not limited to, a service dispatch center, small business location, warehouse, etc.

3) Select any color model that allows the expression of discernible color changes in numeric representations. Examples include, but are not limited to, HSL, HSV, PMS, RGB, CMYK, etc. Each of these systems changes the numeric value of a variable over a specific range of values to establish a specific incremental change in the associated color parameter.

4) Select a color parameter to represent distance in the polar coordinate system.

5) Select a color parameter to represent bearing in the polar coordinate system.

6) Identify/select a bearing reference which will establish the relationship between a specific visible state of a color parameter and the absolute direction it represents. For example, a specific hue could be associated with due North and all other colors can then be mapped to specific compass bearings or range of compass bearings as illustrated in Figure C

7) Develop an administrator input mechanism that allows the administrator to set the input the scale factor which determines the absolute distance represented by the available range of the color parameter selected to represent distance. For example, a particular business may do business over a range of 20 miles from any given resource center. The range of color parameter variations for that resource center then needs to represent a physical distance of 20 miles. Such scaling algorithms are common and well known.

8) Once the color parameters have been selected, the coordinate model is selected, key reference points for the coordinate system have been selected (such as origin and bearing reference for a polar coordinate system) and the distance scaling factor relevant to the application has been selected, a table can be constructed that shows the relationship between color and relative geographic location. Figure H is one of many possible examples illustrating this relationship. In Figure H, the HSL color model was selected and the parameter Hue was chosen to represent bearing on a polar coordinate system and the parameter Lightness was used to represent distance. The resolutions shown are coarse and can be adjusted by the designer as desired through simple and well known scaling and banding algorithms to address the needs of the application.

9) Once parameters are adjusted to deliver the desired color/location relationship, a straightforward color overlay graphic can be generated using the other parameters such as point of origin, bearing reference and distance scaling. Figure C illustrates how the color/location relationship can be expressed in a polar map to illustrate to users how the relationship applies to their specific application. Once that relationship is established, the concept of an “assigned location color” manifests itself and any time an assigned location color is identified, the geographic area it represents becomes identified no matter how that color is presented.

10) With the color/location relationship established, the value of that relationship can be manifested in many ways. By simply associating any information with an assigned location color conveys location information that has some relevance to that information. Figure D provides one of many possible examples where service appointment time slots for each service technician are filled with an assigned location color. That association provides a multitude of benefits described throughout this document.

### SYSTEM IN USE EXAMPLES

### Example 1

### Preventative Service Appointment

1. Customer requests PSA and provides service address and desired time of preventative service appointment to the service agent;

2. The service address and desired time are entered into the software system;

3. The software system uses the service address to determine bearing and distance and displays to the service agent the Service Address Color;

4. The software system displays a multi-day view (Figure D) to provide the service agent the ability to see both available and booked times for appropriate resources. Each booked (non-available) time includes that appointments Service Address Color giving the user a tremendous amount of scheduling information virtually instantaneously;

5. The service agent scans the multi-day view focusing on minimizing travel time by locating other scheduled appointments in the same vicinity (as determined through near instantaneous assessment of distance and bearing associated with color variations or Service Address Color) in the desired time slots;

6. User suggests time to customer that minimizes travel time and distance for technician while still meeting the customer's expectations. As alternatives are discussed with customer, the user can quickly scan for available times giving preference to time slots that require the least amount of travel to fulfill (again, as determined through near instantaneous assessment of distance associated with color pairs Service Address Color); and

7. Negotiations continue until the best business trade-off between choosing the least costly options and the customer's constraints on acceptable service times is identified.

### Example 2

### Rescheduling an Appointment

1. Customer requests to reschedule an appointment;

2. The service agent enters the customer's identifying information (name or address) into the software system;

3. The software system identifies the customer's appointment, displays the appointment's Service Address Color and brings up the relevant section of the software system's multi-day view (Figure D) to provide service agent the ability to see both available and booked times for appropriate resources from the selected origin. Each booked (non-available) time includes that appointment's Service Address Color giving the user a tremendous amount of scheduling information virtually instantaneously;

4. The service agent scans the multi-day view focusing on minimizing travel time by locating other scheduled appointments in the same vicinity (as determined through near instantaneous assessment of distance and bearing associated with color variations or Service Address Color) in the desired time slots;

5. The service agent suggests a time to customer that minimizes travel time and distance for technician while still meeting the customer's expectations. As alternatives are discussed with customer, the user can quickly scan for available times giving preference to time slots that require the least amount of travel to fulfill (again, as determined through near instantaneous assessment of distance associated with color pairs Service Address Color); and

6. Negotiations continue until the best business trade-off between choosing the least costly options and the customer's constraints on acceptable service times is identified.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

1) A method of generating a graphic illustration of logistical data using color assignments comprising the steps of:
converting common geographic location references into a numeric representation such as latitude and longitude;
identifying or selecting a point of origin from which all color assignments will be established;
selecting a color model that allows the expression of discernible color changes in a numeric representations;
selecting a color parameter to represent a distance in a polar coordinate system;
selecting a color parameter to represent a bearing in the polar coordinate system;
identifying or selecting a bearing reference which will establish the relationship between a specific visible state of a color parameter and an absolute direction it represents;
developing an administrator input mechanism that allows an administrator to set the input of a scale factor which determines an absolute distance represented by an available range of the color parameter selected to represent distance;
constructing a table which shows the relationship between color and relative geographic location; and
creating a straightforward color overlay graphic using the other parameters such as point of origin, bearing reference and distance scaling.
